(19) United States
(12) Patent Application Publication
(10) Pub. No.: US 2022/0192145 A1
(43) Pub. Date: Jun. 23, 2022

(54) DISPOSABLE FORM-FITTED ABSORBENT PET BED COVER DEVICE

(71) Applicant: Yved Lopez, La Verne, CA (US)

(72) Inventor: Yved Lopez, La Verne, CA (US)

(21) Appl. No.: 17/131,261

(22) Filed: Dec. 22, 2020

(51) Int. Cl. A01K 1/015; A01K 1/035

(52) U.S. Cl. CPC A01K 1/0157; A01K 1/0353

(57) ABSTRACT

The collapsible and height adjustable shower chair device disclosed herein may allow a user to seat and support a child while in the shower for washing. The device may collapse down into a form factor suitable for storing away, while also providing a height adjustment so that a child is placed at an appropriate height for where a second user may attend to the child. The feet of the device may provide traction and stability to the collapsible and height adjustable shower chair device so that it does not slide on a wet surface and so that it does not tilt forward due to the child shifting their weight. The device may further comprise safety features such as, for example, side bolsters or a seat belt to prevent a child from falling out of the device.

### TECHNICAL FIELD OF THE INVENTION

The present invention relates in general to bed covers, and, more specifically, to a disposable form-fitted absorbent pet bed cover device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A bed sheet is a, usually, rectangular cloth used as a cover for bedding. Bed sheets may be made available as flat or fitted components, and may be used alone or in combination with additional sheets. Conventionally, a fitted sheet may be installed around a matching size mattress, and a flat sheet may then be placed on top of the fitted sheet. Some users may then wish to add additional components, such as blankets, covers, and pillows. Bed sheets may be further colored or decorated, as desired, for aesthetic or functional purposes.

Bed sheets may be made from a variety of materials, but are generally made of soft, flexible cloths comprising cotton, cotton blends, linen, silk, hemp, and other materials. Flat sheets may further comprise sewn-in additions such as hems, collars, patterns, and monograms. In addition to these components, fitted sheets may further comprise an elastic component such as a band, belt, or drawstring to improve their ability to remain fitted on a mattress. In some embodiments fitted bed sheets may have overlapping flaps into which a mattress may be placed, or may include a zipper to close and secure the sheet to the mattress.

A sanitary pad, which may also be known as a sanitary towel or an incontinence pad, is a multi-layered sheet having a high absorbency component for absorbing fluids. Such sanitary pads are often used as a precaution against urinary incontinence, especially in hospitals or even in the home. Users of such pads may include individuals not yet toilet-trained or those experiencing health issues leading to involuntary voiding. Sanitary pads are often placed on top of a mattress under the user so as to prevent fluid damage to the mattress itself in the effect of incontinence.

Sanitary pads comprise multiple components made from a variety of soft and flexible materials. The absorbent component of a sanitary pad may comprise a quilted absorbent material and may be made available in various thicknesses depending on absorbency needs and abilities. In cases where the sanitary pad is intended to be washable the absorbent material may be cotton, while paper may be used if the sanitary pad is intended to be disposable. The non-absorbent component of a sanitary pad, by contrast, may comprise a non-absorbent material, or even a fluid impermeable material, such as plastic or polyurethane to prevent fluid from passing through the pad.

One specific use of sanitary pads is for pets, especially dogs and cats, who may be suffering from a pathology that limits their movement or causes urinary incontinence. Hip dysplasia, for example, which may be common in some breeds of dogs, often prevents a pet from getting up or moving quickly enough to void in an appropriate area. In such cases the pet may void on their own bedding, just as a human user might. An obvious solution to such urinary incontinence is the use of sanitary pads on the pet bedding. Pets, though, especially larger dogs having difficulty with mobility, may shift or displace a sanitary pad placed on their bedding, cancelling its effectiveness. No solution exists for providing a fitted sanitary pad to pet bedding.

Thus, there is a need in the art for a disposable form-fitted absorbent pet bed cover device that may be form fitted to a plurality of standard size pet beds and may provide an absorbent sanitary pad as a precaution against urinary incontinence. The device may comprise, generally, and absorbent pad attached to a fitted bed sheet, and the absorbent pad may be exposed above the bed sheet or may be integrated into the bed sheet as desired. The device may comprise an elastic band, belt, or drawstring, or may comprise overlapping flaps or a zipper, as desired, to prevent the pet bed cover from be removed or shifted by a user. The device may further comprise a disposable device for ease of use and replacement. In some embodiments the device may be washable and reusable. The fitted bed sheet component may further comprise pockets or hems, or may be decorated, as desired, to improve aesthetics and functionality. It is to these ends that the present invention has been developed.

BRIEF SUMMARY OF THE INVENTION

To minimize the limitations in the prior art, and to minimize other limitations that will be apparent upon reading and understanding the present specification, the present invention describes a disposable form-fitted absorbent pet bed cover device.

It is an objective of the present invention to provide a disposable form-fitted absorbent pet bed cover device that may comprise a main body.

It is another objective of the present invention to provide a disposable form-fitted absorbent pet bed cover device that may comprise a sanitary pad.

It is another objective of the present invention to provide a disposable form-fitted absorbent pet bed cover device that may comprise an absorbent component.

It is another objective of the present invention to provide a disposable form-fitted absorbent pet bed cover device that may comprise a fluid impermeable layer.

It is another objective of the present invention to provide a disposable form-fitted absorbent pet bed cover device that may comprise a fitted bed cover.

It is another objective of the present invention to provide a disposable form-fitted absorbent pet bed cover device that may comprise a closure mechanism.

It is another objective of the present invention to provide a disposable form-fitted absorbent pet bed cover device that may comprise an elastic band.

It is another objective of the present invention to provide a disposable form-fitted absorbent pet bed cover device that may comprise an elastic belt.

It is another objective of the present invention to provide a disposable form-fitted absorbent pet bed cover device that may comprise an elastic drawstring.

It is another objective of the present invention to provide a disposable form-fitted absorbent pet bed cover device that may comprise a plurality of overlapping flaps.

It is another objective of the present invention to provide a disposable form-fitted absorbent pet bed cover device that may comprise a zipper.

It is another objective of the present invention to provide a disposable form-fitted absorbent pet bed cover device that may comprise a resilient material of construction.

It is another objective of the present invention to provide a disposable form-fitted absorbent pet bed cover device that may comprise a disposable material of construction.

It is another objective of the present invention to provide a disposable form-fitted absorbent pet bed cover device that may comprise a water-proof material of construction.

It is another objective of the present invention to provide a disposable form-fitted absorbent pet bed cover device that may comprise a reusable material of construction.

It is another objective of the present invention to provide a disposable form-fitted absorbent pet bed cover device that may comprise a multi-component construction.

It is another objective of the present invention to provide a disposable form-fitted absorbent pet bed cover device that may comprise an antimicrobial layer.

It is another objective of the present invention to provide a disposable form-fitted absorbent pet bed cover device that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is an exploded component view of a disposable form-fitted absorbent pet bed cover device, as contemplated by the present disclosure;

FIG. 2 is an isometric perspective view of a first embodiment of a disposable form-fitted absorbent pet bed cover device, as contemplated by the present disclosure;

FIG. 3 is an isometric perspective view of a second embodiment of a disposable form-fitted absorbent pet bed cover device, as contemplated by the present disclosure;

FIG. 4 is an isometric perspective view of a third embodiment of a disposable form-fitted absorbent pet bed cover device, as contemplated by the present disclosure;

FIG. 5 is an isometric perspective view of a fourth embodiment of a disposable form-fitted absorbent pet bed cover device, as contemplated by the present disclosure;

FIG. [symbol] is an isometric perspective view of a fifth embodiment of a disposable form-fitted absorbent pet bed cover device, as contemplated by the present disclosure; and

FIG. 7 is an isometric perspective view of a sixth embodiment of a disposable form-fitted absorbent pet bed cover device, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The disposable form-fitted absorbent pet bed cover device disclosed herein may be form fitted to a plurality of standard size pet beds and may provide an absorbent sanitary pad as a precaution against urinary incontinence. The device may comprise, generally, and absorbent pad attached to a fitted bed sheet, and the absorbent pad may be exposed above the bed sheet or may be integrated into the bed sheet as desired. The device may comprise an elastic band, belt, or drawstring, or may comprise overlapping flaps or a zipper, as desired, to prevent the pet bed cover from be removed or shifted by a user. The device may further comprise a disposable device for ease of use and replacement. In some embodiments the device may be washable and reusable. The fitted bed sheet component may further comprise pockets or hems, or may be decorated, as desired, to improve aesthetics and functionality.

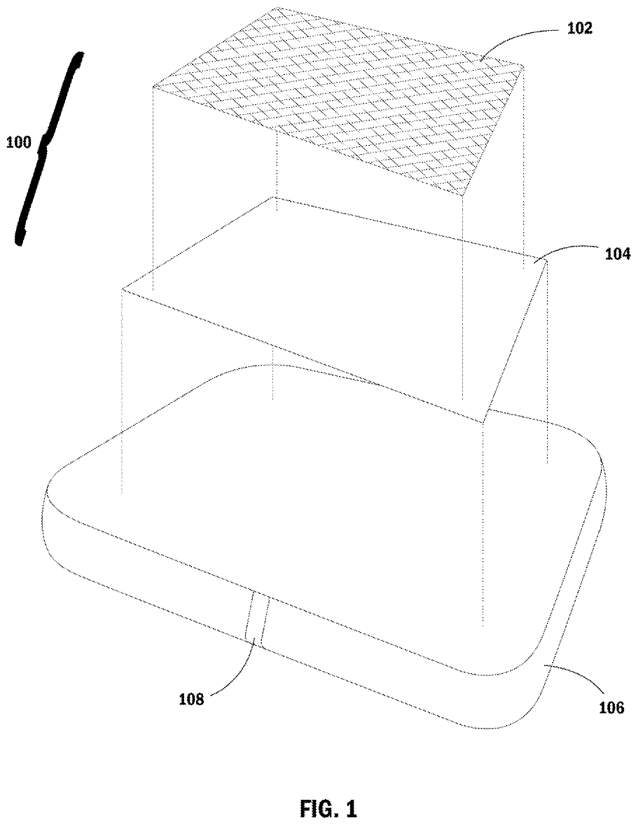

The illustrations of FIGS. 1-7 illustrate a disposable form-fitted absorbent pet bed cover device, as contemplated by the present disclosure. The device may comprise, generally, a main body 100 further comprising an absorbent component 102, a liquid impermeable component 104, a bed sheet 106, and a closure mechanism 108.

The absorbent component 102 may comprise any appropriate absorbent component known in the art. By way of example, the absorbent component 102 may comprise a quilted cotton sheet or a quilted paper sheet designed to absorb fluids.

The liquid impermeable component 104 may comprise any appropriate impermeable layer known in the art. By way of example the liquid impermeable component 104 may comprise a plastic or polyurethane layer to prevent fluid from passing through the layer.

The bed sheet 106 may comprise any appropriate bed sheet known in the art. By way of example, the bed sheet 106 may comprise a cotton, cotton blends, linen, silk, hemp, or plastic layer fitted to a plurality of standardized shapes.

The closure mechanism 108 may comprise any appropriate closure mechanism known in the art. By way of example, the closure mechanism 108 may comprise an elastic band, elastic belt, elastic drawstring, overlapping flaps of cloth, or a zipper designed to close and secure the bed sheet 106 to a pet bed.

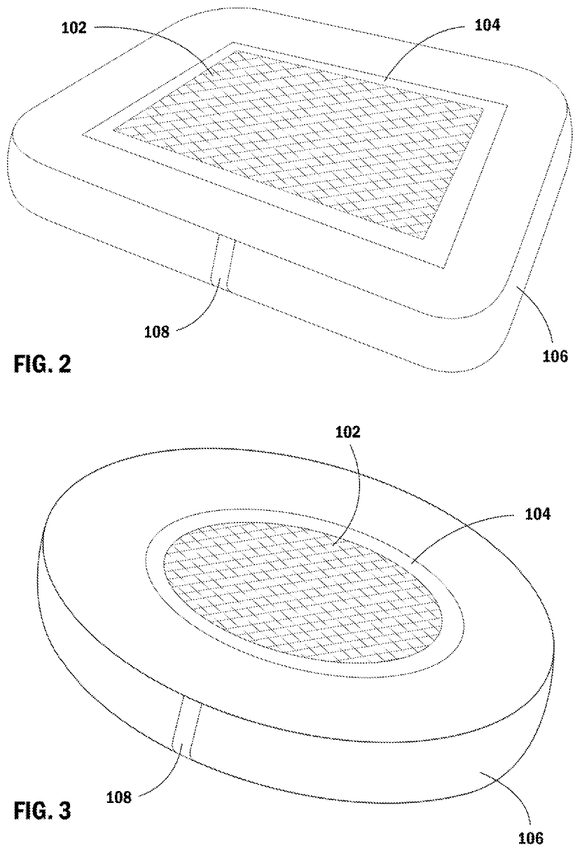

The illustration of FIG. 2 illustrates an isometric perspective view of a first embodiment of a disposable form-fitted absorbent pet bed cover device. In a first embodiment the absorbent component 102 may be attached on an outer surface of the liquid impermeable component 104, which may itself be attached on an outer surface of the bed sheet 106. The bed sheet 106 may comprise a generally cube or cuboid shape such that it may fit over and be fitted to a pet bed having a square or rectangular profile.

The illustration of FIG. 3 illustrates an isometric perspective view of a second embodiment of a disposable form-fitted absorbent pet bed cover device. In a second embodiment the absorbent component 102 may be attached on an outer surface of the liquid impermeable component 104, which may itself be attached on an outer surface of the bed sheet 106. The bed sheet 106 may comprise a generally spherical or egg shape such that it may fit over and be fitted to a pet bed having a circular or oval profile.

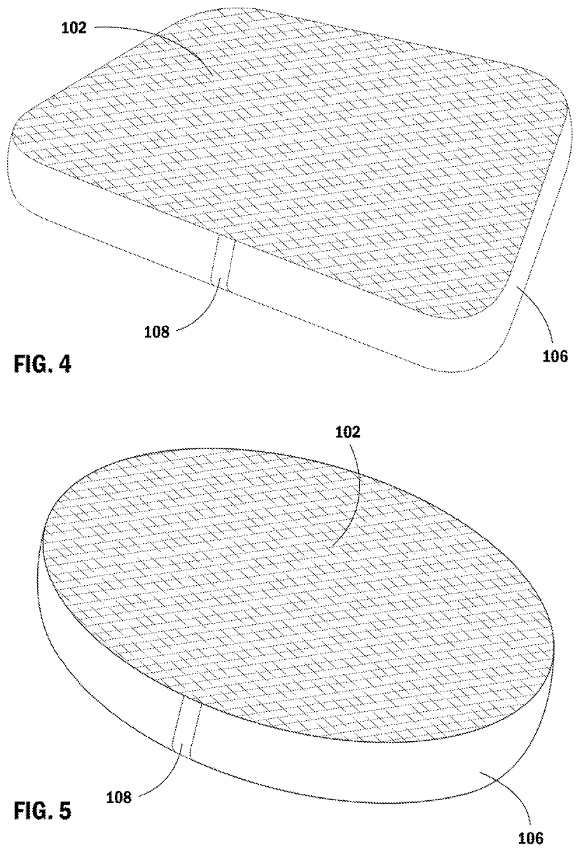

The illustration of FIG. 4 illustrates an isometric perspective view of a third embodiment of a disposable form-fitted absorbent pet bed cover device. In a third embodiment the absorbent component 102 may be attached on an outer surface of the liquid impermeable component 104, which together may define an entire upper surface of the bed sheet 106. The bed sheet 106 may comprise a generally cube or cuboid shape such that it may fit over and be fitted to a pet bed having a square or rectangular profile.

The illustration of FIG. 5 illustrates an isometric perspective view of a fourth embodiment of a disposable form-fitted absorbent pet bed cover device. In a fourth embodiment the absorbent component 102 may be attached on an outer surface of the liquid impermeable component 104, which together may define an entire upper surface of the bed sheet 106. The bed sheet 106 may comprise a generally spherical or egg shape such that it may fit over and be fitted to a pet bed having a circular or oval profile.

The illustration of FIG. 6 illustrates an isometric perspective view of a fifth embodiment of a disposable form-fitted absorbent pet bed cover device. In a fifth embodiment the absorbent component 102 may be attached on an outer surface of the liquid impermeable component 104, which may itself be attached on an upper inner surface of the bed sheet 106. The bed sheet 106 may comprise a generally cube or cuboid shape such that it may fit over and be fitted to a pet bed having a square or rectangular profile.

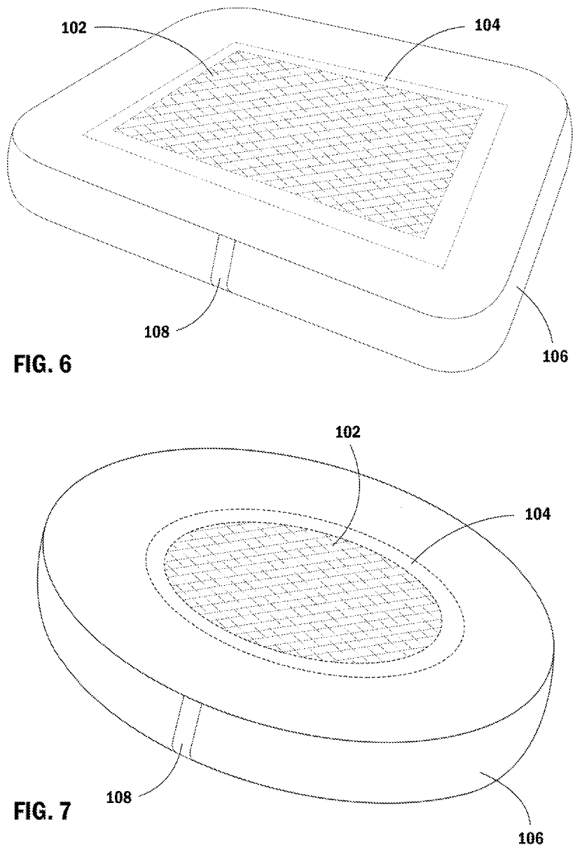

The illustration of FIG. 7 illustrates an isometric perspective view of a sixth embodiment of a disposable form-fitted absorbent pet bed cover device. In a sixth embodiment the absorbent component 102 may be attached on an outer surface of the liquid impermeable component 104, which may itself be attached on an upper inner surface of the bed sheet 106. The bed sheet 106 may comprise a generally spherical or egg shape such that it may fit over and be fitted to a pet bed having a circular or oval profile.

In any embodiment the closure mechanism 108 may be attached to or may comprise a lower surface of the bed sheet 106.

By these various designs the disposable form-fitted absorbent pet bed cover device may be used by first selecting the embodiment desired or appropriate for the pet bed to be covered. An installer may then open the closure mechanism 108 and insert the pet bed into an interior cavity of the device such that the absorbent component 102 is placed against the upper surface of the pet bed. The installer may then close the closure mechanism 108 such that the device stays in place on the pet bed and provides a precaution against urinary incontinence.

In an embodiment wherein the disposable form-fitted absorbent pet bed cover device is disposable the installer may then dispose of the device after it has become soiled. In an embodiment wherein the disposable form-fitted absorbent pet bed cover device is washable and reusable the installer may then wash and reuse the device after it has become soiled.

The disposable form-fitted absorbent pet bed cover device may be substantially constructed of any suitable material or combination of materials, but typically is constructed of a resilient material or combination of materials such that the device is resistant to damage as a result of compression, twisting, heating, or submersion in water. As an example, and without limiting the scope of the present invention, various exemplary embodiments of the disposable form-fitted absorbent pet bed cover device may be substantially constructed of one or more materials of cotton, cotton blends, linen, silk, hemp, silicone, plastic, acrylic, polycarbonate, elastic, or combinations thereof In some embodiments the various components of the device may be coated, lined, or otherwise insulated to prevent contamination of the device.

In one embodiment the disposable form-fitted absorbent pet bed cover device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A disposable form-fitted absorbent pet bed cover device, comprising:
an absorbent component;
a liquid impermeable component;
a bed sheet; and
a closure mechanism;
wherein said absorbent component is attached to an upper side of said liquid impermeable component;
wherein said liquid impermeable component is attached to an upper side of said bed sheet;
wherein said closure mechanism is attached to a lower side of said bed sheet; and
wherein said bed sheet is form-fitted to a pet bed.

2. The invention of claim 1,
wherein said liquid impermeable component is attached to an upper face of said upper side of said bed sheet.

3. The invention of claim 1,
wherein said liquid impermeable component is attached to a lower face of said upper side of said bed sheet.

4. The invention of claim 1,
wherein said absorbent component further comprises a quilted cotton sheet.

5. The invention of claim 1,
wherein said absorbent component further comprises a quilted paper sheet.

6. The invention of claim 1,
wherein said liquid impermeable component further comprises a plastic layer.

7. The invention of claim 1,
wherein said liquid impermeable component further comprises a polyurethane layer.

8. The invention of claim 1,
wherein said bed sheet further comprises a cotton sheet.

9. The invention of claim 1,
wherein said bed sheet further comprises a linen sheet.

10. The invention of claim 1,
wherein said bed sheet further comprises a silk sheet.

11. The invention of claim 1,
wherein said bed sheet further comprises a hemp sheet.

12. The invention of claim 1,
wherein said bed sheet further comprises a plastic sheet.

13. The invention of claim 1,
wherein said closure mechanism further comprises an elastic band.

14. The invention of claim 1,
wherein said closure mechanism further comprises an elastic belt.

15. The invention of claim 1,
wherein said closure mechanism further comprises an elastic drawstring.

16. The invention of claim 1,
wherein said closure mechanism further comprises a plurality of overlapping flaps.

17. The invention of claim 1,
wherein said closure mechanism further comprises a zipper.
